(19) United States
(12) Patent Application Publication
(10) Pub. No.: US 2003/0046063 A1
(43) Pub. Date: Mar. 6, 2003

(54) Combined stylus and method for driving thereof

(75) Inventor: Young-sup Kim, Suwon-si (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/207,089

(22) Filed: Jul. 30, 2002

(30) Foreign Application Priority Data
Sep. 3, 2001 (KR) 2001-53848

(51) Int. Cl. G10L 21/00

(52) U.S. Cl. 704/201

(57) ABSTRACT

A combined stylus in which a mike and a wire/wireless interface are mounted, and a method for driving the combined stylus. The combined stylus transmits user's speech to a personal portable terminal in a wire/wireless manner with built-in mike and speaker in a transmission mode, records speech data that is input and plays back the speech data according to record and playback modes. A mike and a wire/wireless interface are mounted in a stylus, and thereby speech can be transmitted to a terminal without an additional input device while using the function of the stylus. In addition, after the speech is recorded in the stylus, the stored contents can be transmitted to the terminal via a communication module.

### BACKGROUND OF THE INVENTION

1. Field of the Invention

The present invention relates to an apparatus for inputting data into a terminal, and more particularly, to a combined stylus in which a mike and a wire/wireless interface are mounted, and a method for driving the combined stylus. The present application is based on Korean Patent Application No. 2001-53848, filed Sep. 3, 2002, which is incorporated herein by reference.

2. Description of the Related Art

In general, personal terminals such as a personal digital assistant (PDA), which is called a pen-based system, and a palm-sized computer, use styluses for inputting various data thereof. The personal terminals recognize user's speech using a speech recognition technique. However, each terminal requires either a built-in mike or an external mike to allow use of the speech recognition technique. However, there are disadvantages associated with these arrangements. A terminal with a built-in mike has a low rate of speech recognition, and a terminal with an external mike must include an additional device.

### SUMMARY OF THE INVENTION

To solve the above problems, it is a first objective of the present invention to provide a combined stylus, which transmits speech data to a terminal in real-time and also functions as a stylus.

It is a second objective of the present invention to provide a method for driving the combined stylus.

Accordingly, to achieve the first objective, according to one aspect of the present invention, there is provided a combined stylus for inputting speech data into a terminal with a built-in speech recognition program. The stylus includes a mike for converting speech into an electrical signal, an encoder for encoding a speech signal converted in the mike, a memory for storing speech data encoded in the encoder, a communication module unit for modulating the speech data stored in the memory into a high frequency signal and transmitting the high frequency signal to the terminal, a decoder for decoding the speech data stored in the memory, a speaker for playing back the speech data decoded in the decoder, and a controller for transmitting the speech data encoded in the encoder in units of predetermined packets to the terminal via a communication module unit in a transmission mode, and for storing the speech data encoded in the encoder in the memory in a record mode, and for transmitting the speech data stored in the memory to the decoder in a playback mode.

In order to achieve the second objective, there is provided a method for driving a stylus which inputs data into a terminal with a built-in speech recognition program. The method includes inputting a speech signal when a transmission mode for transmitting speech data to the terminal is set, converting the input speech signal into a digital signal and encoding the digital speech signal, packetizing the encoded speech data in units of predetermined packets, and converting the packetized speech data into a radio signal and transmitting the radio signal to the terminal.

### BRIEF DESCRIPTION OF THE DRAWINGS

The above objectives and advantages of the present invention will become more apparent by describing in detail a preferred embodiment thereof with reference to the attached drawings in which:

FIG. 1 illustrates the concept of a combined stylus according to the present invention;

FIG. 2 is a block diagram of the combined stylus according to the present invention; and

FIG. 3 is a flow chart illustrating a method for driving the combined stylus according to the present invention.

### DETAILED DESCRIPTION OF THE INVENTION

The present invention will be described more fully hereinafter with reference to the accompanying drawings in which a preferred embodiment of the invention is shown.

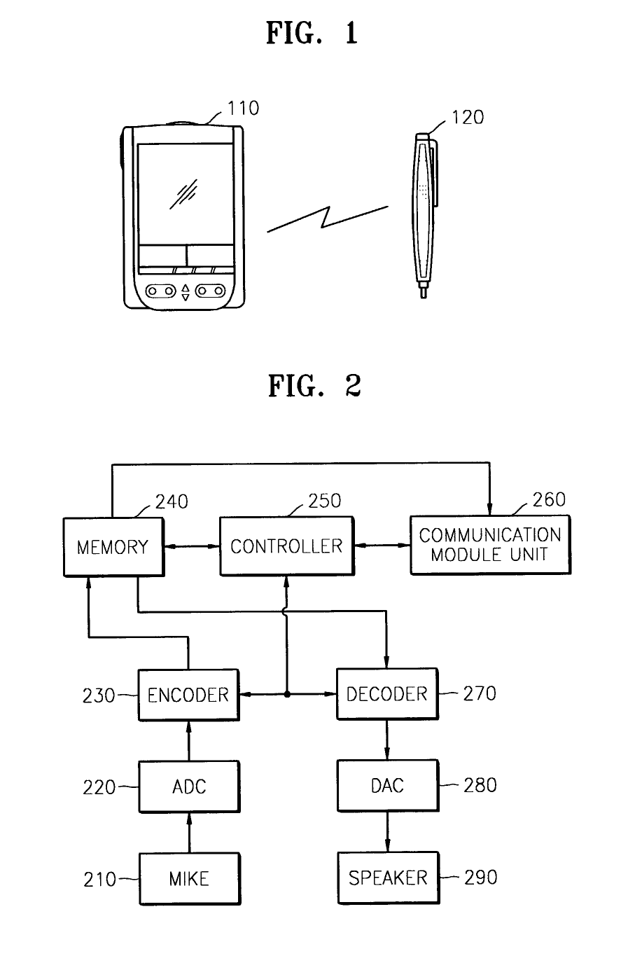

FIG. 1 illustrates the concept of a combined stylus according to the present invention. Referring to FIG. 1, a combined stylus 120 outputs speech data via a wire/wireless link into a personal portable terminal 110. In this case, the combined stylus 120 transmits user's speech to the personal portable terminal 110 via built-in mike and speaker in a wire/wireless manner, records and plays back a speech data that is input according to an operation mode. The personal portable terminal 110 recognizes speech, which is received from the combined stylus 120, via a speech recognition program and performs a corresponding function.

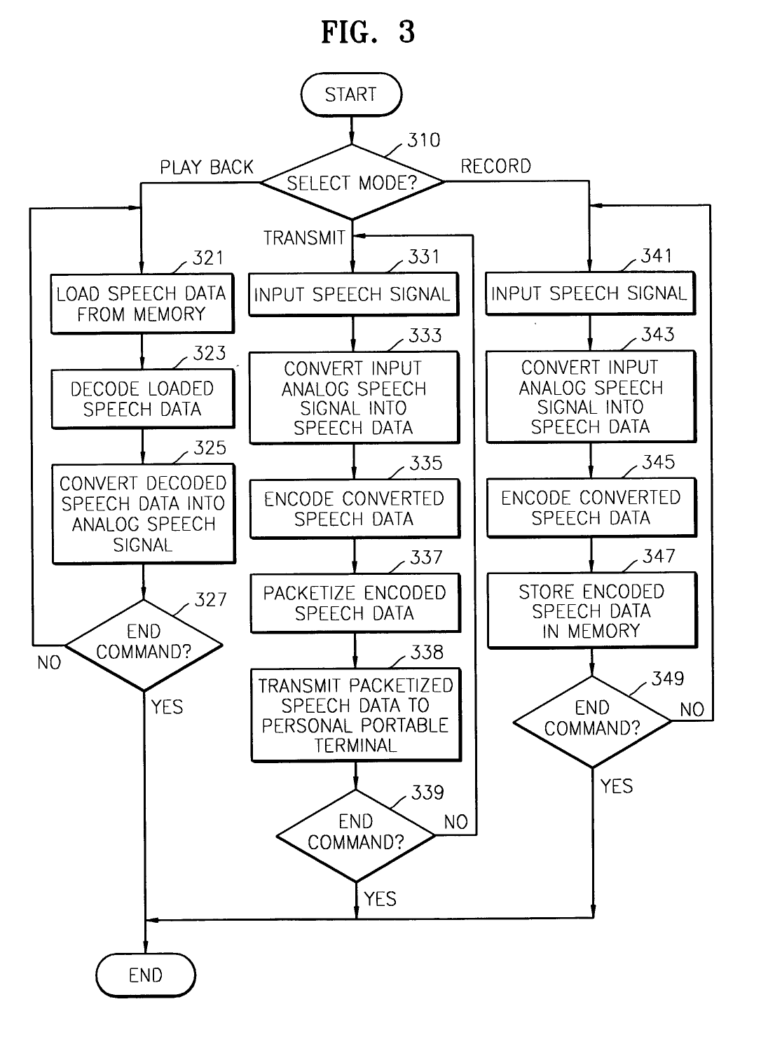

FIG. 2 is a block diagram of the combined stylus according to the present invention. Referring to FIG. 2, a mike 210 converts input speech into an electrical signal. An analog-digital converter (ADC) 220 converts an analog speech signal, which is input from the mike 210, into a digital signal. An encoder 230 encodes speech data that is received from the ADC 220, into a predetermined format. A memory 240 stores the speech data that is encoded in the encoder 230. A decoder 270 restores the speech data, which is compressed and stored in the memory 240, into original speech data. A digital-analog converter (DAC) 280 converts the speech data, which is input from the decoder 270, into an analog speech signal. A speaker 290 plays back the speech data that is decoded in the decoder 270. In another embodiment, the speaker 290 may be replaced with earphones.

A communication module unit 260 modulates the speech data, which is stored in the memory 240, into a high frequency signal and transmits the high frequency signal to the personal portable terminal 110.

A controller 250 determines an operation mode from the press of a button that is attached in a predetermined position. That is, in a case where the controller 250 recognizes the operation mode as a transmission mode, the controller 250 transmits the speech data, which is encoded in the encoder 230, to the communication module unit 260 in units of predetermined packets through the memory 240. In a case where the controller 250 recognizes the operation mode as a record mode, the controller 250 stores the speech data, which is encoded in the encoder 230, in the memory 240. In a case where the controller 250 recognizes a playback mode, the controller 250 outputs the speech data, which is stored in the memory 240, into the decoder 270. The controller 250 controls encoding and decoding of the encoder 230 and the decoder 270.

FIG. 3 is a flow chart illustrating a method for driving the combined stylus according to the present invention. Referring to FIG. 3, in step 310, an operation mode such as a transmission mode in which speech data is transmitted, a record mode in which speech is recorded, and a playback mode in which the recorded speech is played back, is selected with a button that is attached in a predetermined position. Subsequently, an additional stylus operation is performed according to the selected operation mode.

First, if the transmission mode is selected, then in step 331 a speech signal is input from the mike 210. In step 333, the input analog speech signal is converted into speech data. In step 335, the speech data is encoded. Subsequently, in step 337, the encoded speech data is packetized in a predetermined unit. In step 338, the packetized speech data is converted into the format of a radio signal and is transmitted to the personal portable terminal 110. In step 339, the above steps are repeated until a transmission mode end command is detected.

Second, if the record mode is selected, then in step 341 a speech signal is input from the mike 210. In step 343, the input analog speech signal is converted into speech data. In step 345, the converted speech data is encoded. In step 347, the encoded speech data is stored in the memory 240. In step 349, the above steps are repeated until the record mode end command is detected.

Third, if the playback mode is selected, then in step 321 speech data that is stored in the memory 240 is loaded. In step 323, the loaded speech data is decoded into an original speech signal. In step 325, the decoded speech signal is converted into an analog speech signal. In step 327, the above steps are repeated until the playback mode end command is detected.

While this invention has been particularly shown and described with reference to preferred embodiments thereof, it will be understood by those skilled in the art that various changes in form and details may be made therein without departing from the spirit and scope of the invention as defined by the appended claims. For example, the present invention is not limited to a stylus but may be applied to a digitizer. The memory may be any suitable storage medium, such as, but not limited to, a semiconductor memory, a magnetic recording medium, an optical recording medium, etc. Information related to a current proceeding state, can be indicated by further attaching a display such as a liquid crystal display (LCD) to the stylus according to the present invention. Also, operating modes can be selected utilizing any suitable selection device instead of a button. For example, but not by way of limitation, the selection device could be a touch screen, a pointing device, a voice recognition apparatus, an infrared or sonic remote control unit, etc.

As described above, according to the present invention, a mike and a wire/wireless interface are mounted in a stylus, and thereby speech can be transmitted to a terminal without an additional input device while using the function of the stylus. In addition, after the speech is recorded in the stylus in an environment in which the terminal cannot be used, in case of need, stored contents can be transmitted to the terminal via a communication module.

What is claimed is:

1. A combined stylus in a stylus terminal for inputting speech data into a terminal with a built-in speech recognition program, the stylus comprising:
a mike for converting speech into an electrical signal;
an encoder for encoding a speech signal, derived from the electrical signal converted in the mike, into encoded speech data;
a memory for storing the encoded speech data encoded in the encoder;
a communication module unit for modulating the encoded speech data stored in the memory into a high frequency signal and transmitting the high frequency signal to the terminal;
a decoder for decoding the encoded speech data stored in the memory into decoded speech data;
a speaker for playing back the decoded speech data decoded in the decoder; and
a controller for transmitting the encoded speech data encoded in the encoder in units of predetermined packets to the terminal via a communication module unit in a transmission mode, and for storing the encoded speech data encoded in the encoder in the memory in a record mode, and for transmitting the encoded speech data stored in the memory to the decoder in a playback mode.

2. The combined stylus of claim 1, further comprising a button for selecting each of the transmission mode, the record mode and the playback mode.

3. A method for driving a stylus which inputs data into a terminal with a built-in speech recognition program, the method comprising:
inputting a speech signal when a transmission mode for transmitting a speech data to the terminal is set;
converting the input speech signal into a digital signal and encoding the digital speech signal into encoded speech data;
packetizing the encoded speech data in units of predetermined packets; and
converting the packetized speech data into a radio signal and transmitting the radio signal to the terminal.

4. The method of claim 3, further comprising the step of encoding the digital speech signal into encoded speech data and storing the encoded speech data when a speech record mode is set.

5. The method of claim 3, further comprising the steps of:
storing the encoded speech data; and
decoding the stored speech data and playing back the speech data when a speech playback mode is set.

6. An apparatus for inputting speech data into a terminal, the apparatus comprising:
means for converting speech into a speech signal;
means for encoding the speech signal into encoded speech data;
means for storing the encoded speech data;
modulating means for modulating the encoded speech data stored in the means for storing into a modulated signal and transmitting the modulated signal to the terminal;
means for decoding the encoded speech data stored in the means for storing into decoded speech data;
means for playing back the decoded speech data; and
means for controlling transmission of the encoded speech data in units of predetermined packets to the terminal via a communication module unit in a transmission mode, and for storing the encoded speech data in the means for storing in a record mode, and for transmitting the encoded speech data stored in the means for storing to the decoder in a playback mode.

7. The apparatus of claim 6, wherein the terminal incorporates a speech recognition system.

8. The apparatus of claim 6, further comprising means for selecting among the transmission mode, the record mode and the playback mode.
